(19) United States
(12) Patent Application Publication
(10) Pub. No.: US 2008/0242428 A1
(43) Pub. Date: Oct. 2, 2008

(54) GAMING MACHINE CAPABLE OF PERFORMING MINI GAME

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/020,647

(22) Filed: Jan. 28, 2008

Related U.S. Application Data
(60) Provisional application No. 60/907,267, filed on Mar. 27, 2007.

(51) Int. Cl. A63F 9/24; G06F 17/00

(52) U.S. Cl. 463/43

(57) ABSTRACT

A gaming machine according to the present invention comprising: a writing device capable of writing information into a portable storage medium carried by a player; a reading device capable of reading information from the portable storage medium; and a controller, the controller programmed to conduct the processing of: (a) executing a mini game in which a point value may be offered to the player; (b) writing the point value into the portable storage medium through the writing device; (c) reading the point value written into the portable storage medium, through the reading device; and (d) executing a bonus game, the bonus game is more advantageous to the player compared to a normal game in which a game medium may be offered and is capable of being executed by consuming the point value.

### CROSS-REFERENCE TO RELATED APPLICATIONS

This application claims benefit of priority based on U.S. Provisional Patent Application No. 60/907,267 filed on Mar. 27, 2007. The contents of this application are incorporated herein by reference in their entirety.

### BACKGROUND OF THE INVENTION

1. Field of the Invention

The present invention relates to a gaming machine capable of executing a mini game.

2. Discussion of the Background

Conventionally, there has been a slot machine which executes a free game in the case of the establishment of a predetermined condition (for example, a specific symbol should be stop-displayed in a slot machine game) during a game. The free game is a game which can be executed without consuming a game medium. For example, as disclosed in AU 1972901-A, there is a slot machine which executes a free game as a sub game, in the case of the establishment of the predetermined condition (symbols are displayed in a specific manner) during a main game.

Further, in recent years, there has been a gaming machine which executes a mini game for a player to acquire a point value during an execution of a special game which is more advantageous to the player compared to a normal game, and allows the player to use the point value acquired in the mini game, in a bonus game (for example, a free game) executed thereafter.

It is an object of the present invention to provide a gaming machine capable of executing a mini game, thereby offering new entertainment.

The contents of AU 1972901-A is incorporated herein by reference in its entirety.

### SUMMARY OF THE INVENTION

According to a first aspect of the present invention, there is provided a gaming machine having the following structure.

Namely, the above-mentioned gaming machine comprises a writing device capable of writing information into a portable storage medium carried by a player; a reading device capable of reading information from the portable storage medium; and a controller. The controller is programmed to conduct the processing of: (a) executing a mini game in which a point value may be offered to the player; (b) writing the point value into the portable storage medium through the writing device; (c) reading the point value written into the portable storage medium, through the reading device; and (d) executing a bonus game, the bonus game is more advantageous to the player compared to a normal game in which a game medium may be offered and is capable of being executed by consuming the point value.

According to a second aspect of the present invention, there is provided a gaming machine having the following structure.

Namely, the above-mentioned gaming machine comprises a controller. The controller is programmed to conduct the processing of: (a) executing a mini game in which a point value may be offered to the player; (b) storing the point value in an external management device which is communicably connected to the gaming machine through a communication line; (c) reading the point value stored in the management device; and (d) executing a bonus game, the bonus game is more advantageous to the player compared to a normal game in which a game medium may be offered and is possible to be executed by consuming the point value.

### BRIEF DESCRIPTION OF THE DRAWINGS

FIG. 1 is a flow chart illustrating a subroutine of mini-game processing which is conducted by a mother board included in a gaming machine according to a present embodiment.

FIG. 2 is a perspective view schematically illustrating the external structure of the gaming machine according to the present embodiment.

FIG. 3 is a view illustrating an exemplary image which is displayed to a lower image display panel.

FIG. 4 is another view illustrating an exemplary image which is displayed to the lower image display panel.

FIG. 5 is a view illustrating an exemplary gaming card used in the present embodiment.

FIG. 6 is a schematic view illustrating symbol columns which are displayed to respective display blocks.

FIG. 7 is a block diagram illustrating the internal structure of the gaming machine illustrated in FIG. 2.

FIG. 8 is a flow chart illustrating a subroutine of game execution processing which is conducted by the motherboard included in the gaming machine according to the present embodiment.

FIG. 9 is a view for explaining a relationship among a plurality of types of prizes, the probabilities of establishment of the respective prizes, and the numbers of payouts for the respective prizes, in a normal game according to the present embodiment.

FIG. 10 is a flow chart illustrating a subroutine of bonus-game processing.

FIG. 11 is a view illustrating an exemplary correspondence between to-be-consumed point value and the number of free games to be executed.

FIG. 12 is a view for explaining a relationship among a plurality of types of prizes, the probabilities of establishment of the respective prizes, and the numbers of payouts for the respective prizes, in a bonus game according to the present embodiment.

FIG. 13 is a flow chart illustrating a subroutine of symbol determination processing.

FIG. 14 is a diagrammatic view illustrating the entire structure of a game system according to the present embodiment.

### DESCRIPTION OF THE EMBODIMENTS

An embodiment of the present invention will be described with reference to the drawings.

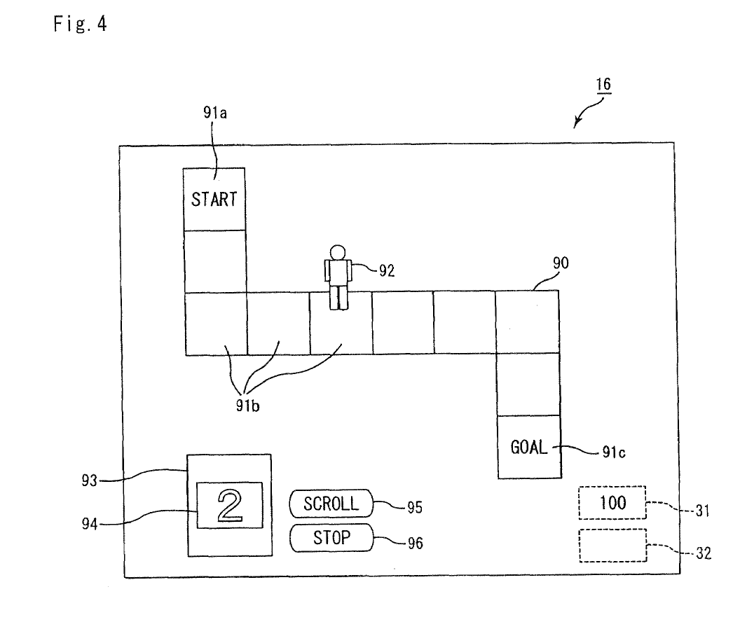

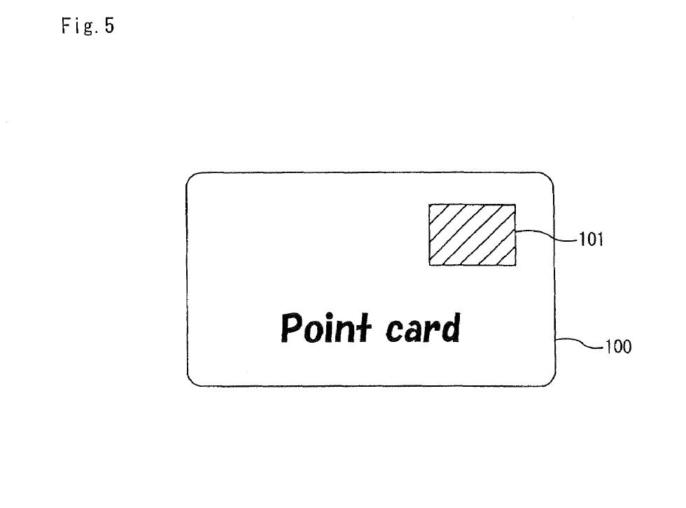

In the present embodiment, a slot machine game is executed, as a normal game in which a game medium (for example, a coin, and a bill) may be offered. When a predetermined condition (a condition that a mini-game trigger should be established) is satisfied in this slot machine game, a mini game, in which a point value may be offered, is executed. In the mini game according to the present embodiment, there is displayed a board comprised of a plurality of squares (see FIG. 4) including squares of “START” and “GOAL”. In the mini game, determining a number by a mini slot, a player move a piece from the square of “START” toward the square of “GOAL,” by the number of squares corresponding to the determined number. Then, when the piece reaches the square of “GOAL,” the point value is offered. The less the number of stops the piece make before reaching the square of “GOAL” is, the greater the point value to be offered is. After the mini game ends, a bonus game which is more advantageous to the player compared to the normal game is executed. In the present embodiment, the bonus game is comprised of a free game which can be played without consuming the game medium. The free game is a slot machine game. In the bonus game, a single or a plurality times of free games are executed. In the bonus game, it is possible to increase the number of free games by consuming the point value. Further, it is possible to store the point value offered to the player in the mini game in a gaming card (see FIG. 5) carried by the player. It is possible for the player to consume the point value on another gaming machine, by inserting the gaming card storing the point value into a card reader in another gaming machine to have this gaming machine read the point value. It is also possible for the player to consume the point value at a later date, by having a gaming machine read the point value stored in the gaming card.

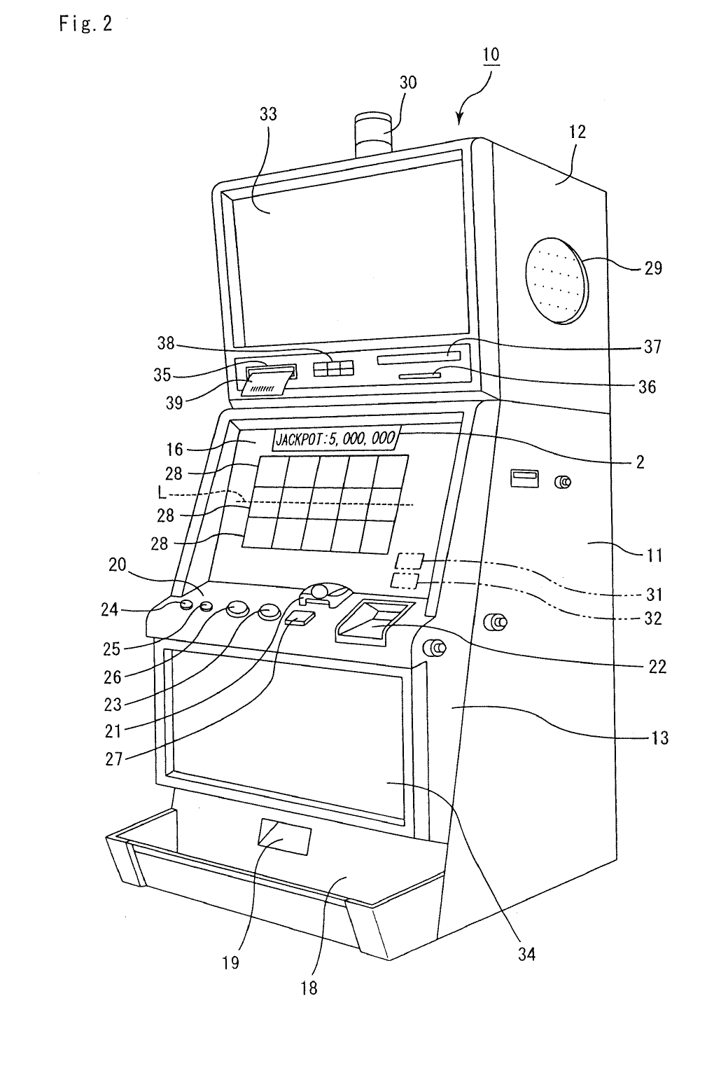

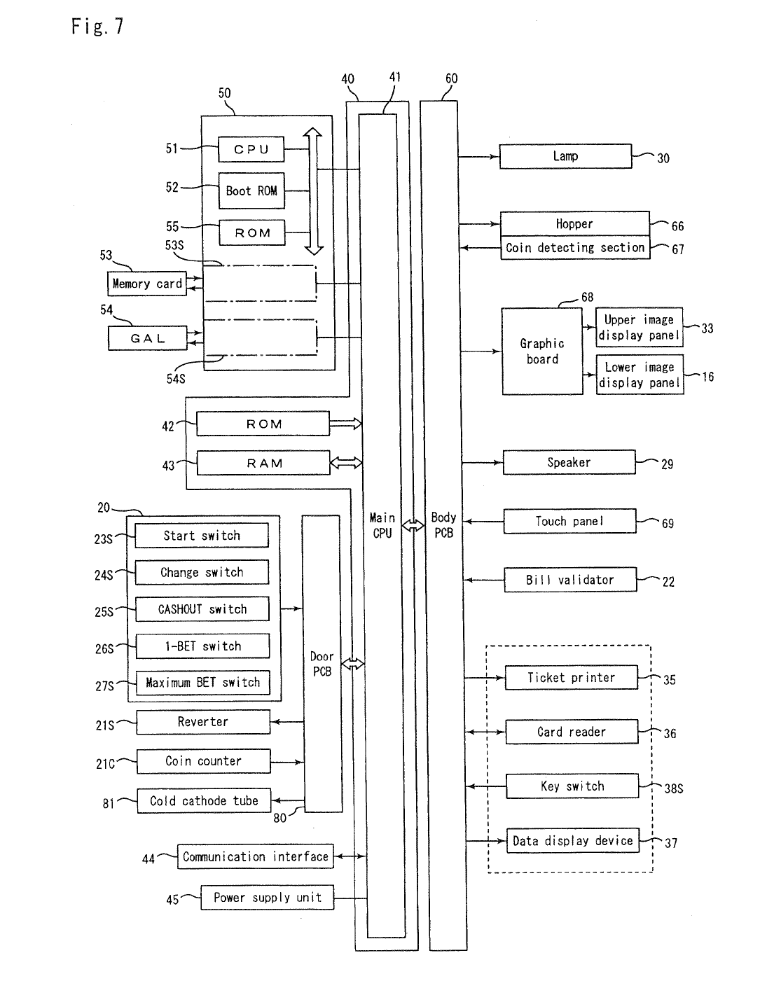

First, there will be described mini-game processing which is conducted by a mother board 40 (see FIG. 7) included in a gaming machine 10 (see FIG. 2) according to the present embodiment.

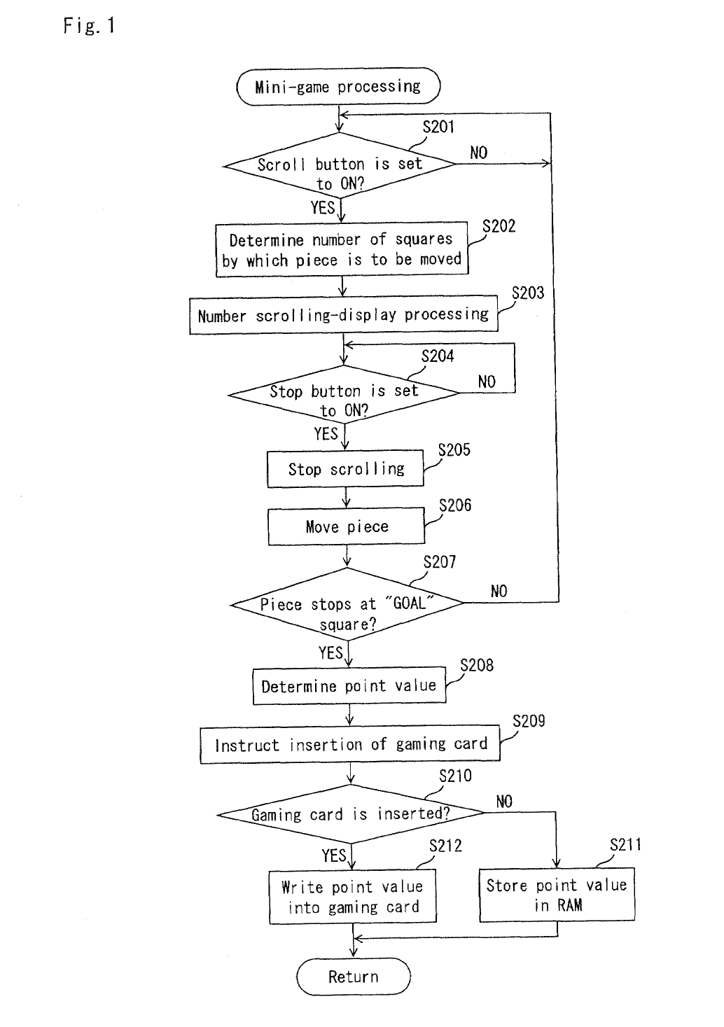

FIG. 1 is a flow chart illustrating a subroutine of the mini-game processing which is conducted by the mother board included in the gaming machine according to the present embodiment. The mini-game processing is the processing conducted in the case where the mini-game trigger is established in the normal game.

At first, in step S201, a main CPU 41 (see FIG. 7) included in the mother board 40 determines whether or not a scroll button 95 (see FIG. 4) is set to “ON.” Namely, the main CPU 41 determines whether or not the scroll button 95 has been operated through a touch panel 69 (see FIG. 7). When determining that the scroll button 95 is not “ON,” the main CPU 41 returns the processing to step S201.

On the other hand, when determining that the scroll button 95 is “ON,” in step S202, the main CPU 41 determines the number of squares by which a piece 92 (see FIG. 4) is to be moved, out of numbers 0 to 9 using random numbers.

Next, in step S203, the main CPU 41 conducts processing for scroll-displaying the numbers 0 to 9, on a number scrolling-display section 94 (see FIG. 4) in a lower image display panel 16 (see FIG. 2).

Next, in step S204, the main CPU 41 determines whether or not a stop button 96 (see FIG. 4) is set to “ON.” Namely, the main CPU 41 determines whether or not the stop button 96 has been operated through the touch panel 69. When determining that the stop button 96 is not “ON,” the main CPU 41 returns the processing to step S204.

On the other hand, when determining that the stop button 96 is “ON,” in step S205, the main CPU 41 stop-displays the number determined in step S202, in the number scrolling-display section 94.

Next, in step S206, the main CPU 41 conducts processing for moving the piece 92 by the number of squares determined in step S202 from the currently-standing square. Further, when the piece 92 reaches a square 91c in which “GOAL” is displayed (see FIG. 4) in the processing in step S206, the piece 92 stops at the square 91c regardless of the remaining number of squares by which the piece 92 is to be moved.

Next, in step S207, the main CPU 41 determines whether or not the piece 92 has stopped at the square 91c in which “GOAL” is displayed. When determining that the piece 92 has not stopped at the square 91c, the main CPU 41 returns the processing to step S201.

On the other hand, when determining that the piece 92 has stopped at the square 91c, in step S208, the main CPU 41 determines the point value to be offered based on the number of stops the piece 92 has made before reaching the square 91c. More specifically, when the piece 92 has stopped once (the piece 92 moved by nine squares at once from the square 91a of “START” [see FIG. 4]), ten points are offered. When the piece 92 has stopped twice (when the piece 92 moved by two squares, and then moved by seven squares, for example), nine points are offered. When the piece 92 has stopped three times (when the piece 92 moved by two squares, then by three squares, and by four squares, for example), eight points are offered. When the piece 92 has stopped more than three times, five points are offered.

However, in the present invention, the correspondence between the number of stops the piece has made and the point value to be offered is not limited to the above-mentioned example.

Further, in the present embodiment, the point value is determined according to the number of stops that the piece has made. However, the present invention is not limited to the case. For example, when the piece reaches the square of “GOAL,” then points of a fixed value may be offered, regardless of the number of stops the piece has made.

Next, in step S209, the main CPU 41 displays, to the lower image display panel 16, an image which instructs the player to insert a gaming card 100 (see FIG. 5) into a card reader 36 (see FIG. 2). More specifically, the main CPU 41 displays an image describing “please insert a gaming card, if you have.”

Next, in step S210, the main CPU 41 determines whether or not the gaming card 100 has been inserted therein. When determining that the gaming card 100 has not been inserted therein, in step S211, the main CPU 41 stores, in a RAM 43, the point value determined to be offered.

On the other hand, when determining that the gaming card 100 has been inserted therein, in step S212, the main CPU 41 writes the point value determined to be offered, into an IC chip 101 (see FIG. 5) included in the inserted gaming card 100, through the card reader 36.

By shifting to a bonus game with the gaming card 100 being inserted in the card reader 36, it is possible to have the gaming machine 10 read the point value stored in the gaming card 100 through the card reader 36 and consume the point value. Further, it is also possible to consume the point value on another gaming machine by inserting the gaming card 100 storing the point value into the card reader in another gaming machine and having this gaming machine read the point value.

After the processing in step S211 or step S212 is conducted, the present subroutine ends.

Next, the gaming machine 10 according to the present embodiment will be described.

FIG. 2 is a perspective view schematically illustrating the external structure of the gaming machine according to the present embodiment.

In the present embodiment, the gaming machine 10 is a video slot machine. However, in the present invention, the gaming machine is not limited to the video slot machine. Examples thereof may include a rotational-reel type slot machine, a video card gaming machine, and the like.

In the gaming machine 10, a coin, a bill or electronic valuable information corresponding to those is used, as a game medium. However, in the present invention, the game medium is not particularly limited. Examples of the game medium may include a medal, a token, electronic money and a ticket. It is to be noted that the ticket is not particularly limited, and examples thereof may include a ticket with a barcode as described later.

The gaming machine 10 comprises a cabinet 11, a top box 12 installed on the upper side of the cabinet 11, and a main door 13 provided at the front face of the cabinet 11.

At the front side of the main door 13, there is provided the lower image display panel 16. The lower image display panel 16 is provided with a transparent liquid crystal display panel to which a variety of information concerning the game, an effect image and the like are displayed during the game. The lower image display panel 16 included in the gaming machine 10 according to the present embodiment comprises a transparent liquid crystal display panel which displays fifteen display blocks 28 in five columns and three rows, when executing the normal game and the bonus game. A single symbol is displayed to each display block 28. Namely, three symbols are displayed along each symbol column. Further, on the lower image display panel 16, there is formed a single winning line L horizontally crossing over the five display blocks 28 displayed along the center row. The winning line L is for determining a combination of symbols. When the combination of symbols stop-displayed along the winning line L is a predetermined combination, the number of coins according to that combination and the number of inserted coins (the number of BETs) are paid out. Further, an image indicating the value of a jackpot (hereinafter also referred to as a JP) is also displayed to the lower image display panel 16.

In the lower image display panel 16, there are provided a number-of-credits display section 31 and a number-of-payouts display section 32. To the number-of-credits display section 31, an image indicating the number of credited coins is displayed. To the number-of-payouts display section 32, an image is displayed, the image indicates the number of coins to be paid out when the combination of symbols stop-displayed along the winning line L is a predetermined combination.

Further, in the present invention, for example, it may be possible to provide a configuration such that there are formed a plurality of winning lines L crossing horizontally or diagonally over the fifteen display blocks 28, and the winning lines L in number according to the number of inserted coins are verified. Further, when the combination of symbols stop-displayed along the verified winning line L is the predetermined combination, coins are paid out in number according to the combination.

Further, although not illustrated, a touch panel 69 is provided on the front face of the lower image display panel 16. The player can operate the touch panel 69 to input a variety of commands.

Below the lower image display panel 16, there are provided a control panel 20 comprised of a plurality of buttons 23 to 27 with each of which a command according to game progress is inputted by the player, a coin receiving slot 21 through which a coin is accepted into the cabinet 11, and a bill validator 22.

The control panel 20 is provided with a spin button 23, a change button 24, a CASHOUT button 25, a 1-BET button 26 and a maximum BET button 27. The spin button 23 is used for inputting a command to start scrolling display on the fifteen display blocks 28. The change button 24 is used for making a request of a staff in the recreation facility for exchange. The CASHOUT button 25 is used for inputting a command to pay out credited coins to a coin tray 18.

The 1-BET button 26 is used for inputting a command to bet one coin, out of the credited coins, on the game. The maximum BET button 27 is used for inputting a command to bet the maximum number of coins that can be bet on one game (fifty coins in the present embodiment), out of the credited coins, on the game.

The bill validator 22 not only discriminates a regular bill from a false bill, but also accepts the regular bill into the cabinet 11. Further, the bill validator 22 may be configured so as to be capable of reading a later-described ticket 39 with a barcode. At the lower front of the main door 13, namely below the control panel 20, there is provided a belly glass 34 on which a character or the like of the gaming machine 10 is drawn.

On the front surface of the top box 12, there is provided an upper image display panel 33. The upper image display panel 33 is provided with a liquid crystal panel to display, for example, an image representing introduction of contents of a game, and explanation of a rule of the game.

Further, on the top box 12, a speaker 29 is provided. Under the upper image display panel 33, there are provided a ticket printer 35, a card reader 36, a data display device 37 and a key pad 38. The ticket printer 35 prints on a ticket a barcode as coded data of the number of credits, a date, identification number of the gaming machine 10, and the like, and outputs the ticket as a ticket 39 with a barcode. The player can have another gaming machine read the ticket 39 with a barcode to play a game thereon, or exchange the ticket 39 with a barcode with a bill and the like at a predetermined place in the recreation facility (e.g. a cashier in a casino).

The card reader 36 reads data from the gaming card 100 and writes data into the gaming card 100, based on the command from the main CPU 41. The card reader 36 corresponds to a writing device and a reading device according to the present invention. The gaming card 100 is a card owned by the player and data indicative of the point value offered to the player in the mini game is stored therein. The data display device 37 is comprised of a fluorescent display and the like, and displays, for example, data read through the card reader 36 or data inputted by the player through the key pad 38. The key pad 38 is used for inputting a command concerning issuing of a ticket and a point value to be consumed in the bonus game.

Next, there will be described an image displayed to the lower image display panel.

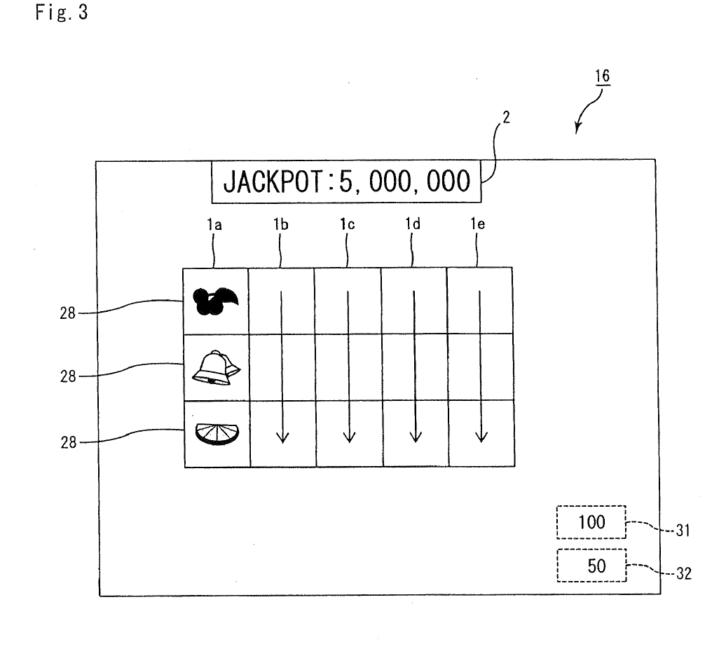

FIGS. 3 and 4 are views illustrating exemplary images which are displayed to the lower image display panel.

FIG. 3 is an exemplary image which is displayed to the lower image display panel 16 when the normal game and the bonus game are executed.

As illustrated in FIG. 3, at the upper side of the lower image display panel 16, there is provided a JP display section 2 for displaying the value of a JP. At the lower side of the JP display section 2, there are displayed the fifteen display blocks 28 in five columns and three rows. The display blocks 28 form five display block columns 1a to 1e. Symbols are stop-displayed to the display block column 1a out of these, while to the other four display block columns 1b to 1e, symbols are variably displayed. In the figure, downward-pointing arrows indicate symbols being variably displayed thereto. Further, at a lower right portion of the lower image display panel 16, there are provided the number-of-credits display section 31 and the number-of-payouts display section 32.

FIG. 4 illustrates an exemplary image which is displayed to the lower image display panel 16 when the mini game is executed.

As illustrated in FIG. 4, at the upper side of the lower image display panel 16, there are displayed a board 90 and a piece 92. The board 90 is comprised of a square 91a in which “START” is displayed, a square 91c in which “GOAL” is displayed, and the other squares 91b. At the start of the mini game, the piece 92 is placed in the square 91a and, thereafter, the piece 92 is moved toward the square 91c based on the determined numbers.

Further, at the lower side of the lower image display panel 16, there is provided a mini-slot display section 93. In the mini-slot display section 93, there is provided a number scrolling-display section 94 for scroll-displaying the number thereon. The piece 92 is moved by the number of squares corresponds to the number which is stop-displayed to the number scrolling-display section 94.

Further, at the right side of the mini-slot display section 93, there are provided the scroll button 95 and the stop button 96. When the scroll button 95 is operated through the touch panel 69, the number is scroll-displayed to the number scrolling-display section 94, and when the stop button 96 is operated, the number is stop-displayed to the number scrolling-display section 94.

FIG. 5 is a view illustrating an exemplary gaming card used in the present embodiment.

As illustrated in FIG. 5, the gaming card 100 is provided with an IC chip 101. The point value offered in the mini game is stored in a memory 102 (not illustrated) included in the IC chip 101.

While in the present embodiment, there will be described a case where a card including an IC chip is employed as a portable storage medium, the portable storage medium according to the present invention is not particularly limited, provided that it is the storage medium carried by the player, namely a carriageable storage medium. Examples thereof may include a magnetic stripe card or a USB memory.

Next, there will be described the symbol column which is displayed when the normal game and the bonus game are executed.

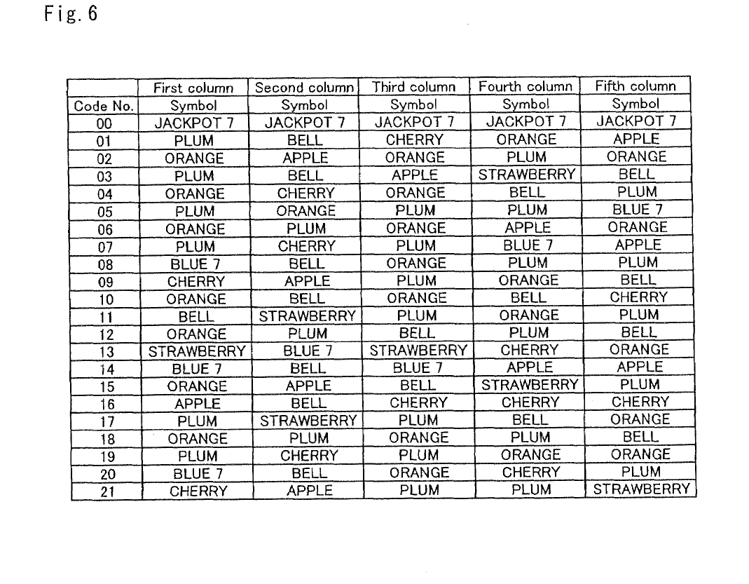

FIG. 6 is a schematic view illustrating the symbol columns which are displayed to the respective display blocks.

As described above, to the lower image display panel 16, there are displayed the fifteen display blocks 28 in five columns and three rows. A single symbol is displayed to each display block 28.

As illustrated in FIG. 6, an array of 22 symbols in total, each of which has a code number out of “00” to “21,” is scrolled along each of the five symbol columns in the respective display blocks 28. Each array of symbols is comprised of a combination of symbols: “JACKPOT 7,” “BLUE 7,” “BELL,” “STRAWBERRY,” “PLUM,” “CHERRY,” “ORANGE,” and “APPLE.”

When five same symbols of “JACKPOT 7,” “BLUE 7,” “BELL,” “STRAWBERRY,” “PLUM,” “CHERRY,” or “ORANGE” are stop-displayed along the winning line L, the predetermined number of coins are paid out.

In the normal game, “APPLE” is a mini-game trigger (a symbol to make a shift to the mini game). When five symbols of “APPLE” are stop-displayed along the winning line L in the normal game, the player can make the shift to the mini game.

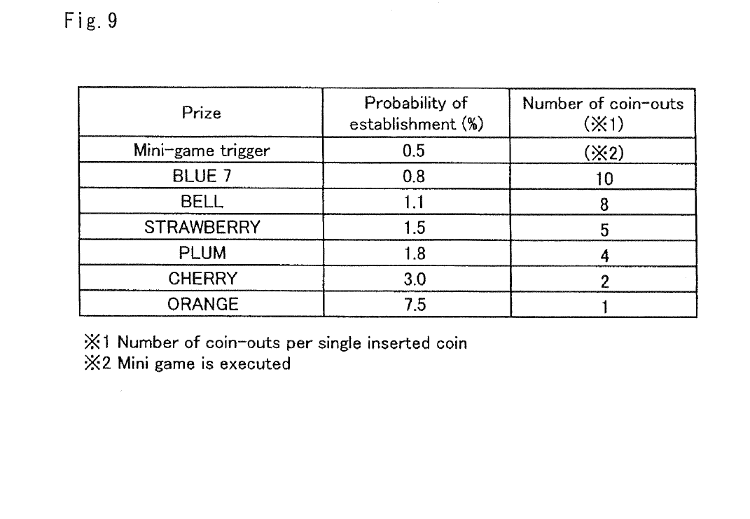

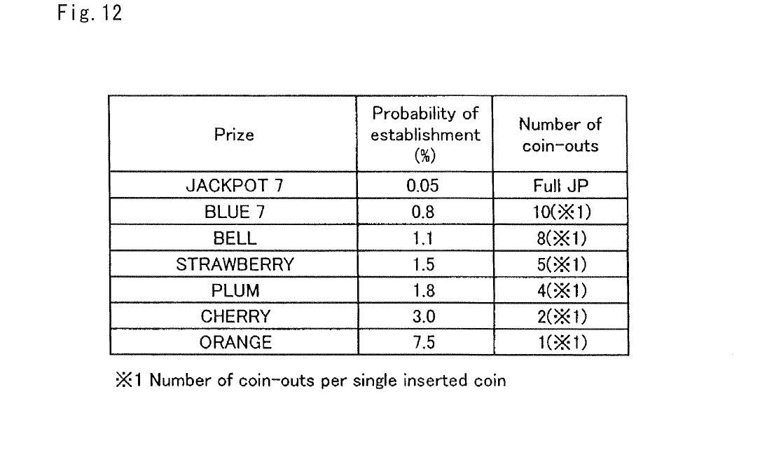

When the spin button 23 is pressed to start the game after the 1-BET button 26 or the maximum BET button 27 is pressed, symbols are scroll-displayed in the downward direction, to the respective display blocks 28. Then, after the elapse of a predetermined time period, symbols are stop-displayed. Further, various types of prizes (see FIGS. 9 and 12) are predetermined based on the combinations of respective symbols. When a combination of symbols corresponding to a prize stops along the winning line L, the number of coin-outs corresponding to the prize is added to the credit owned by the player. Further, in the case where the mini-game trigger is established in the normal game, the mini game is generated.

Further, in the present embodiment, there will be described a case where symbols are automatically stop-displayed after the elapse of the predetermined time period since the start of scrolling display of symbols to the display blocks 28. However, the present invention is not limited to the case, and the slot machine 10, for example, may be provided with a stop button and symbols may be stop-displayed when the above-mentioned stop button is pressed.

FIG. 7 is a block diagram illustrating the internal structure of the gaming machine illustrated in FIG. 2.

A gaming board 50 is provided with a CPU (Central Processing Unit) 51, a ROM 55, and a boot ROM 52 which are interconnected to one another by an internal bus, a card slot 53S corresponding to a memory card 53, and an IC socket 54S corresponding to a GAL (Generic Array Logic) 54.

The memory card 53 is comprised of a nonvolatile memory such as CompactFlush (registered trade mark), and stores a game program. The game program includes a symbol determination program. The symbol determination program is a program for determining a symbol (code No. corresponding to the symbol) to be stop-displayed along the winning line L.

Further, the card slot 53S is configured so as to allow the memory card 53 to be inserted thereinto or ejected therefrom, and is connected to the mother board 40 by an IDE bus. Therefore, the type and contents of a game played on the gaming machine 10 can be changed by ejecting the memory card 53 from the card slot 53S, and writing another game program into the memory card 53, and then inserting the memory card 53 into the card slot 53S. The game program includes a program relating to progression of the game. Further, the game program includes image data and sound data to be outputted during the game.

The CPU 51, the ROM 55, and the boot ROM 52, which are interconnected to one another by the internal bus, are connected to the mother board 40 through a PCI bus. The PCI bus not only conducts signal transmission between the mother board 40 and the gaming board 50, but also supplies electric power from the mother board 40 to the gaming board 50.

The mother board 40 is configured using a commercially available general-purpose mother board (a print wiring board on which fundamental components of a personal computer are mounted), and comprises the main CPU 41, a ROM (Read Only Memory) 42, a RAM (Random Access Memory) 43, and a communication interface 44. The mother board 40 corresponds to a controller according to the present invention.

The ROM 42 is comprised of a memory device such as a flash memory, and stores a program such as a BIOS (Basic Input/Output System) executed by the main CPU 41 and permanent data. When the BIOS is executed by the main CPU 41, processing for initializing a predetermined peripheral device is conducted, concurrently with start of processing for loading the game program stored in the memory card 53 through the gaming board 50. Also in the present invention, the ROM 42 may or may not be data rewritable one.

The RAM 43 stores data and a program to be used at the time of activation of the main CPU 41. Also, the RAM 43 is capable of storing a game program.

Also, the RAM 43 stores data of the number of credits, the number of coin-ins and coin-outs in a single game, and the like.

Further, the mother board 40 is connected with a later-described body PCB (Printed Circuit Board) 60 and a door PCB 80 through respective USBs. Further, the mother board 40 is connected with a power supply unit 45.

The body PCB 60 and the door PCB 80A are connected with an equipment and a device, which generate an input signal to be inputted into the main CPU 41, and an equipment and a device, operations of which are controlled by a control signal outputted from the main CPU 41. The main CPU 41 executes the game program stored in the RAM 43 based on the input signal inputted into the main CPU 41, and thereby executes the predetermined arithmetic processing and stores the result thereof into the RAM 43, or transmits a control signal to each equipment and device as processing for controlling each equipment and device.

The body PCB 60 is connected with a lamp 30, a hopper 66, a coin detecting section 67, a graphic board 68, a speaker 29, a touch panel 69, a bill validator 22, a ticket printer 35, a card reader 36, a key switch 38S and a data display device 37. The lamp 30 is lighted in a predetermined pattern based on a control signal outputted from the main CPU 41.

The hopper 66 is installed inside the cabinet 11, and pays out a predetermined number of coins based on the control signal outputted from the main CPU 41, from the coin payout exit 19 onto the coin tray 18. The coin detecting section 67 is provided inside the coin payout exit 19, and outputs an input signal to the main CPU 41 in the case of detecting payout of the predetermined number of coins from the coin payout exit 19.

The graphic board 68 controls image display to the upper image display panel 33 and the lower image display panel 16 based on the control signal outputted from the main CPU 41. To the respective display blocks 28 of the lower image display panel 16, a background color determined by selecting a random number is displayed, and also symbols are scroll-displayed or stop-displayed. The number-of-credits display section 31 of the lower image display panel 16 displays the number of credits stored in the RAM 43. Further, the number-of-payouts display section 32 of the lower image display panel 16 displays the number of coin-outs.

The graphic board 68 comprises a VDP (Video Display Processor) for generating image data based on the control signal outputted from the main CPU 41, a video RAM for temporarily storing image data generated by the VDP, and the like. Further, image data used in generating the image data by the VDP is included in the game program, which is read from the memory card 53 and stored in the RAM 43.

The bill validator 22 not only discriminates a regular bill from a false bill, but also accepts the regular bill into the cabinet 11. The bill validator 22, on accepting the regular bill, outputs an input signal to the main CPU 41 based on a face amount of the bill. The main CPU 41 stores in the RAM 43 the number of credits corresponding to the face amount of the bill transmitted by the input signal.

The ticket printer 35, based on the control signal outputted from the main CPU 41, prints on a ticket a barcode formed by encoding data such as the number of credits stored in the RAM 43, a date, and an identification number of the gaming machine 10, and outputs the ticket as the ticket 39 with a barcode.

The card reader 36 reads data from the gaming card 100 and transmits the read data to the main CPU 41, and writes data into the gaming card 100 based on the control signal from the main CPU 41. The key switch 38S is provided on the key pad 38, and outputs a predetermined input signal to the main CPU 41 when the key pad 38 is operated by the player. The data display device 37 displays data read by the card reader 36 and data inputted by the player through the key pad 38 based on the control signal outputted from the main CPU 41.

The door PCB 80 is connected with a control panel 20, a reverter 21S, a coin counter 21C and a cold cathode tube 81. The control panel 20 is provided with a start switch 23S corresponding to the spin button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. The start switch 23S outputs, to the CPU 41, a signal indicating that a game starts, when the spin button 23 is pressed. The respective switches 23S to 27S output input signals to the main CPU 41 when each of the buttons 23 to 27 corresponding thereto is operated by the player.

The coin counter 21C is provided inside the coin receiving slot 21, and discriminates a regular coin from a false coin inserted into the coin receiving slot 21 by the player. Coins other than the regular coin are discharged from the coin payout exit 19. Further, the coin counter 21C, on detecting the regular coin, outputs an input signal to the main CPU 41.

The reverter 21S operates based on the control signal outputted from the main CPU 41, and distributes the coin recognized as the regular coin by the coin counter 21C into a cash box (not illustrated) or the hopper 66, which are disposed in the gaming machine 10. Namely, when the hopper 66 is filled with coins, the regular coin is distributed into the cash box by the reverter 21S. On the other hand, when the hopper 66 is not filled with coins, the regular coin is distributed into the hopper 66. The cold cathode tube 81 functions as a back light installed on the rear face side of the lower image display panel 16 and the upper image display panel 33, and is lighted based on the control signal outputted from the main CPU 41.

Next, there will be described processing conducted by the mother board 40. However, the mini-game processing has been already described with reference to FIG. 1, and the description thereof will not be repeated here.

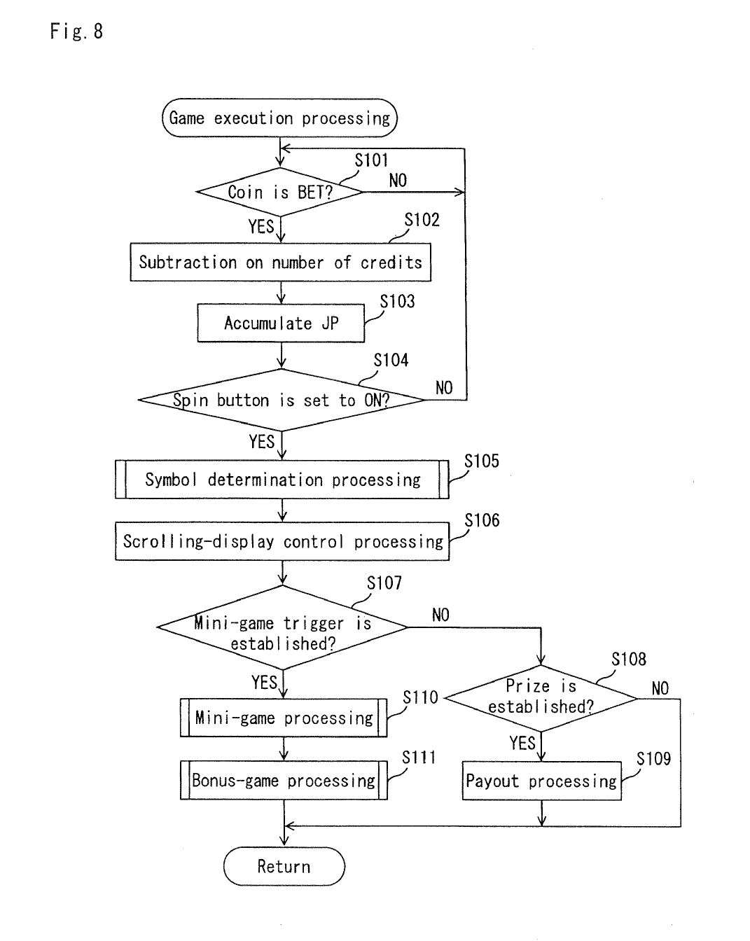

FIG. 8 is a flow chart illustrating a subroutine of game execution processing which is conducted by the mother board included in the gaming machine according to the present embodiment.

First, in step S101, the main CPU 41 determines whether or not a coin has been BET. In this processing, the main CPU 41 determines whether or not to have received an input signal which is to be outputted from the 1-BET switch 26S when the 1-BET button 26 has been operated, or an input signal which is to be outputted from the maximum BET switch 27S when the maximum BET switch 27 has been operated. When the main CPU 41 determines that no coin has been BET, the processing is returned to step S101.

On the other hand, when determining that the coin has been BET in step S101, the main CPU 41 conducts processing for performing a subtraction on the number of credits stored in the RAM 43 according to the number of coins BET in step S102. Further, when the number of coins BET is larger than the number of credits stored in the RAM 43, the main CPU 41 does not conduct the processing for performing a subtraction on the number of credits stored in the RAM 43, and return the processing to step S101. Further, when the number of coins BET exceeds the upper limit of the number of coins that can be BET on a single game (50 coins in the present embodiment), the main CPU 41 does not conduct the processing for performing a subtraction on the number of credits stored in the RAM 43, and shifts the processing to step S103.

Next, in step S103, the main CPU 41 cumulatively stores, in the RAM 43, ten percent of the BET credits as a JP.

Next, in step S104, the main CPU 41 determines whether or not the spin button 23 has been set to ON. In this processing, the main CPU 41 determines whether or not to have received a signal outputted from the start switch 23S when the spin button 23 has been pressed.

When determining that the spin button 23 has not been set to ON, the main CPU 41 returns the processing to step S101.

Further, when the spin button 23 has not been set to ON (for example, when a command to end the game is inputted without setting the spin button 23 to ON), the main CPU 41 cancels the result of the subtraction in step S102.

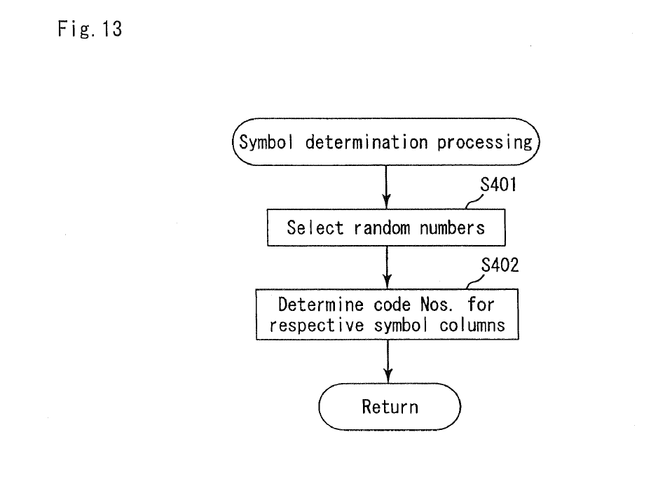

On the other hand, when determining that the spin button 23 has been set to ON in step S104, the main CPU 41 conducts symbol determination processing in step S105. In this symbol determination processing, the main CPU 41 executes a symbol determination program stored in the RAM 43 to determine a code No. of the symbol in stopping. Thereby, a combination of symbols to be stop-displayed is determined. This processing will be specifically described later with reference to FIG. 13. Further, in the present embodiment, there will be described a case where the combination of symbols to be stop-displayed is determined so as to determine a single prize out of a plurality of types of prizes. However, in the present invention, for example, a single prize to be selected out of a plurality of types of prizes may be determined first, and thereafter, the combination of symbols to be stop-displayed may be determined based on the above-mentioned prize.

Next, in step S106, the main CPU 41 conducts scrolling-display control processing.

This processing is processing for starting scrolling display of symbols and stopping the scrolling display in the respective display blocks 28 such that the combination of symbols determined in step S105 is stop-displayed along the winning line L.

Next, in step S107, the main CPU 41 determines whether or not the mini-game trigger has been established, namely whether or not five symbols of “APPLE” have been stop-displayed along the winning line L. When determining that the mini-game trigger has not been established, the main CPU 41 determines whether or not a prize has been established in step S108. When determining that a prize has been established, the main CPU 41 pays out the coin according to the number of inserted coins and the prize (step S109). In the case of accumulating the coin, the main CPU 41 conducts processing for adding the number of credits stored in the RAM 43. On the other hand, in the case of paying out the coin, the main CPU 41 transmits a control signal to the hopper 66 to pay out the predetermined number of coins.

Here, there will be described the prize in the normal game according to the present embodiment.

FIG. 9 is a view for explaining the relationship among a plurality of types of prizes, the probabilities of establishment of the respective prizes, and the numbers of coin-outs for the respective prizes in the normal game according to the present embodiment.

When five symbols of “APPLE” are stop-displayed along the winning line L and the mini-game trigger is won, the mini game is generated.

Further, when five symbols of “BLUE 7” are stop-displayed along the winning line L, ten coins are paid out per single inserted coin. Similarly, when five same symbols of “BELL,” “STRAWBERRY,” “PLUM,” “CHERRY,” or “ORANGE” are stop-displayed along the winning line L, coins in number corresponding to the prize for each combination are paid out.

The processing for conducting steps S101 to S109 corresponds to processing for executing the normal game according to the present invention.

When determining, in step S107, that the mini-game trigger has been established, the main CPU 41 reads a program for executing the mini game from the RAM 43 and executes the mini-game processing of FIG. 1, in step S110.

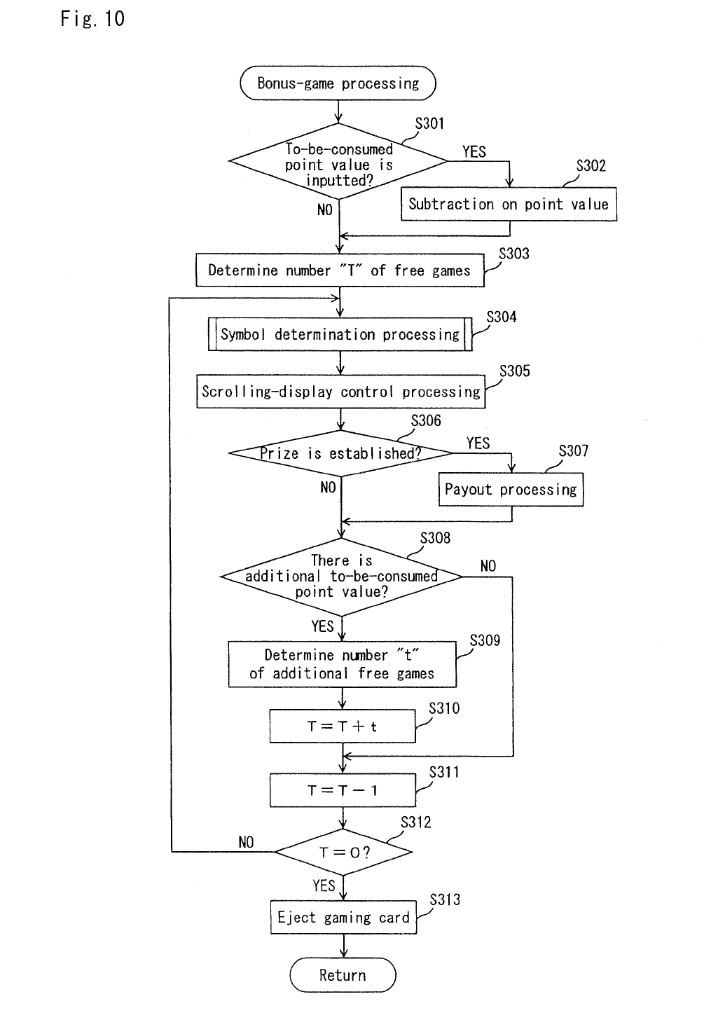

Next, in step S111, the main CPU 41 reads a program for executing the bonus game from the RAM 43, and executes bonus-game processing. The bonus-game processing is processing for executing a free game according to the consumed point value, which will be specifically described later with reference to FIG. 10.

When conducting the processing in step S109 or step S111, or when determining, in step S108, that no prize has been established (when determining that no-winning has occurred), the main CPU 41 ends the present subroutine.

FIG. 10 is a flow chart illustrating a subroutine of the bonus-game processing which is conducted in step S111 in FIG. 8.

First, in step S301, the main CPU 41 determines whether or not points value to be consumed (hereinafter, also referred to as a to-be-consumed point value) has been inputted. Namely, the main CPU 41 determines whether or not an input for setting a point value to be consumed by the player has been performed through the key pad 38.

When determining that a to-be-consumed point value has been inputted, the main CPU 41 conducts, in step S302, processing for subtracting the to-be-consumed point value from the point value stored in the gaming card 100, through the card reader 36.

Further, when no gaming card 100 is inserted, the main CPU 41 conducts processing for subtracting the to-be-consumed point value from the point value stored in the RAM 43.

When conducting the processing in step S302, or when determining, in step S301, that no to-be-consumed point value has been inputted (or that a to-be-consumed point value of zero has been inputted), in step S303, the main CPU 41 determines the number “T” of free games to be executed.

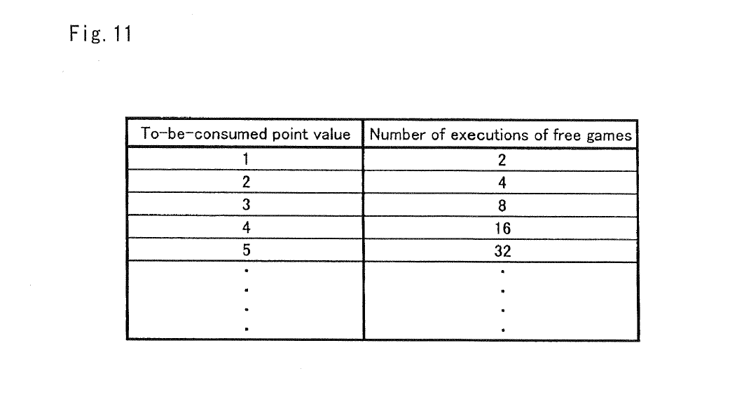

Here, there will be described the relationship between the to-be-consumed point value and the number of free games to be executed. FIG. 11 is a view illustrating exemplary correspondence between the to-be-consumed point value and the number of free games to be executed. As illustrated in FIG. 11, when the to-be-consumed point value is one, a free game is executed twice (the first power of two). Further, when the to-be-consumed point value is two, a free game is executed four times (the second power of two). Further, when the to-be-consumed point value is three, a free game is executed eight times (the third power of two). As described above, the number of free games to be executed is exponentially increased with the to-be-consumed point value.

When the to-be-consumed point value is zero, the number “T” of free games is set to one.

Next, in step S304, the main CPU 41 conducts symbol determination processing. In this symbol determination processing, the main CPU 41 executes the symbol determination program stored in the RAM 43 to determine the code Nos. of the symbols at the time of a stoppage. Accordingly, the combination of symbols to be stop-displayed is determined. This processing will be specifically described later with reference to FIG. 13.

Next, in step S305, the main CPU 41 conducts scrolling-display control processing. This processing is processing for starting scrolling display of symbols and then stopping the scrolling display on the respective display blocks 28 such that the combination of symbols determined in step S304 is stop-displayed along the winning line L.

Next, the main CPU 41 determines whether or not the prize has been established in step S306.

When determining that the prize has been established, the main CPU 41 pays out coins according to the number of inserted coins and the prize (step S307).

Here, there will be described the prize in the bonus game according to the present embodiment.

FIG. 12 is a view for explaining the relationship among a plurality of types of prizes, the probabilities of establishment of the respective prizes, and the numbers of coin-outs for the respective prizes, in the bonus game according to the present embodiment.

When five symbols of “JACKPOT 7” are stop-displayed along the winning line L, the entire amount of JP cumulatively stored in the RAM 43 is paid out.

Further, when five symbols of “BLUE 7” are stop-displayed along the winning line L, ten coins are paid out per single inserted coin. Similarly, when five same symbols of “BELL,” “STRAWBERRY,” “PLUM,” “CHERRY,” or “ORANGE” are stop-displayed along the winning line L, coins in number corresponding to the prize for each combination are paid out.

When conducting the processing in step S307, or when determining, in step S306, that no prize has been established (when determining that no-winning has occurred), the main CPU 41 determines whether or not the to-be-consumed point value has been added, in step S308. Namely, the main CPU 41 determines whether or not an additional input of the to-be-consumed point value has been performed through the key pad 38. When determining that no to-be-consumed point value has been added, the main CPU 41 returns the processing to step S311.

On the other hand, when determining that the to-be-consumed point value has been added, in step S309, the main CPU 41 conducts the processing for performing a subtraction on the point value stored in the gaming card 100 or the RAM 43, and then determines the number “t” of free games to be additionally executed. In this processing, the main CPU 41 determines the value of “t” based on the correspondence between the to-be-consumed point value and the number of free games illustrated in FIG. 11. In the present embodiment, the correspondence between the to-be-consumed point value and the number of free games illustrated in FIG. 11 is used in determining the number “t” of additional free games. However, in the present invention, the number of additional free games may be determined based on the correspondence different from that in FIG. 11.

Next, in step S310, the main CPU 41 conducts processing for adding the value of “t” determined in step S309 to the value of “T”.

Next, in step S311, the main CPU 41 conducts processing for subtracting 1 from the value of “T”.

Next, in step S312, the main CPU 41 determines whether or not the value of “T” is zero. When determining that the value of “T” is not zero, the main CPU 41 returns the processing to step S304.

The processing for conducting steps S304 to S312 is processing for executing the free game. The free game corresponds to a unit game according to the present invention.

On the other hand, when determining that the value of “T” is zero, in step S313, the main CPU 41 ejects the gaming card 100 from the card reader 36, in the case where the gaming card 100 has been inserted therein.

After conducting the processing in step S313, the main CPU 41 ends the present subroutine.

FIG. 13 is a flow chart illustrating a subroutine of the symbol determination processing which is conducted in step S105 in FIG. 8 and in step S304 in FIG. 10. This processing is processing conducted through the execution, by the main CPU 41, of the symbol determination program stored in the RAM 43.

First, the main CPU 41 executes a random-number generation program included in the symbol determination program, to select random numbers corresponding to the respective symbol columns, out of a numerical range from 0 to 255 (step S401). In the present embodiment, there will be described a case where random numbers are generated on the program (in a case where so-called software random numbers are used). However, in the present invention, a random-number generator may be provided, and random numbers may be extracted from this random-number generator (so-called hardware random numbers may be used).

Next, the main CPU 41 determines code Nos. for the respective symbol columns (see FIG. 6) based on the selected five random numbers (step S402). The code Nos. for the symbol columns correspond to the code Nos. for symbols which are to be stop-displayed along the winning line L. The main CPU 41 determines the prize by determining code Nos. for the respective symbol columns. For example, when the main CPU 41 determines the code Nos. for the respective symbols to be “00,” “00,” “00,” “00,” and “00,” this indicates that the main CPU 41 determines “JACKPOT 7” as the prize.

After conducting the processing in step S402, the main CPU 41 ends the present subroutine.

Next, there will be described a game system according to the present embodiment.

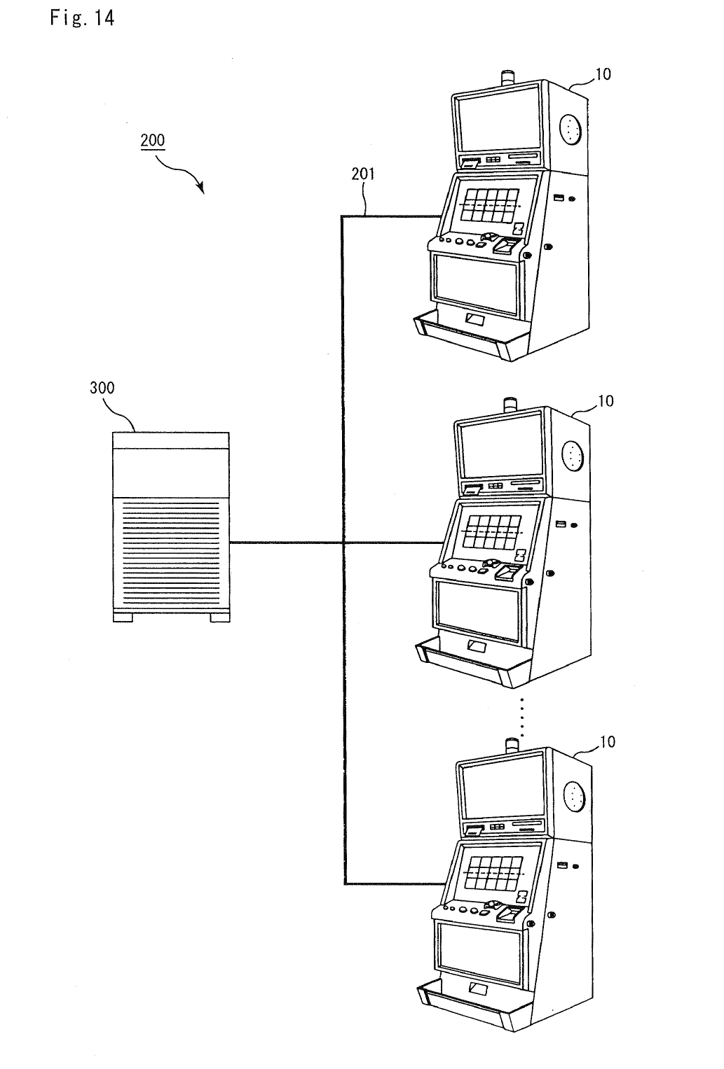

FIG. 14 is a diagrammatic view illustrating the entire structure of the game system according to the present embodiment.

The game system 200 comprises a plurality of gaming machines 10 and a control server 300 connected with a communication interface 44 in these gaming machines 10 through a predetermined communication line 201. The game system 200 as described above may be constructed in a single recreation facility where a variety of games can be played, such as a bar or a casino, or constructed among a plurality of recreation facilities. Further, in the case of constructing the game system 200 in a single recreation facility, the game system 200 may be constructed on each floor or in each section of the recreation facility. The communication line 201 is not particularly limited, and may be either wired or wireless, and a dedicated line, an switched line or the like can be adopted.

While in the present embodiment, the point value offered to the player is stored in the IC chip 101 in the gaming card 100, in the present invention, the point value offered to the player in the mini game may be stored in the control server (the external management device). In this case, for example, there may be a configuration that identification information (ID data and a password) of the player is stored in the control server along with the point value, and when the player plays the game with a gaming machine communicably connected to the control server, he or she can consume the point value stored in the control server by inputting the ID data and the password. Further, as another example, a configuration may be provided that the point value is stored in the control server in association with identification information of the player and the identification information of the player is stored in the gaming card, so that the player's point value stored in the control server may be consumed based on the identification information stored in the inserted gaming card.

As described above, the gaming machine 10 according to the present embodiment is provided with the card reader 36 (the writing device and the reading device) capable of writing information into the gaming card 100 carried by the player and also capable of reading information from the gaming card 100. Further, the gaming machine 10 is provided with the mother board 40 (the controller) programmed to conduct the processing of: (a) executing a mini game in which a point value may be offered; (b) writing the point value into the gaming card 100 through the card reader 36; (c) reading the point value written in the gaming card 100 through the card reader 36; and (d) executing the bonus game, the bonus game is more advantageous to the player compared to the normal game in which the game medium may be offered and is possible to be executed by consuming the point value.

In the present embodiment, there has been described a case where the mini game is a game in which a piece is moved along a plurality of squares based on the number determined by a mini slot. However, the mini game according to the present invention is not limited to the above-mentioned example, provided that it is a game in which a point value may be offered. However, it is preferable that the mini game according to the present invention is comprised of a plurality of steps, where based on the result of the game at a single step, the game at the next step is started. Namely, it is preferable that the mini game according to the present invention is a game in which the result of the game at a single step affects the content and/or the result of the game at the next step. An exemplary mini game is a game in which playing cards are selected at random one by one and the ranks of the cards are successively added, and when the total sum of the ranks reaches a predetermined number, a point value is offered. In this case, the rank of a single selected card affects the total sum of the ranks after the addition of the rank of the subsequently selected card. Further, another exemplary mini game is a game in which a plurality of card games is successively executed, and when a predetermined poker hand is established, a Pai-Gow poker is executed, and then, a point value is offered to a player when the player wins against a banker in the Pai-Gow poker.

Namely, it is preferable that the mini game according to the present invention is a game which has a plot continued through all the steps. Another examples of the game having a plot include a game of going through a labyrinth from a start toward a goal and a game in which a story is carried forward.

In the case of employing the labyrinth or the story in the mini game, there may be provided a branch which causes the player to select a single step out of a plurality of steps (for example, branches in the labyrinth, decision branches which cause the player to select the subsequent action in the story). In this case, the point value may be offered in a lump sum to the player at the end of the game (for example, at the step where the player reaches the goal in the labyrinth or at the step corresponding to the ending of the story). Also, the point value maybe offered to the player halfway through the game (for example, at the step where the player makes a choice at a branching point in the labyrinth or at the step where the player selects the subsequent action in the story).

Further, the mini game according to the present invention is not particularly limited, provided that it is a game in which a point value may be offered. However, it is preferable that the mini game according to the present invention is a game in which no point value can be consumed.

Further, while in the present embodiment, the mini game is generated during the execution of the normal game, in the present invention, the mini game may be generated during the execution of the bonus game.

In the present embodiment, there has been described a case where a game comprised of a free game (slot machine game) is executed as the bonus game, the free game is more advantageous to the player compared to the normal game in that it is possible to play without consuming the game medium. However, the bonus game according to the present invention is not particularly limited, provided that the bonus game is a game which is more advantageous to the player compared to the normal game (for example, a game in which a greater amount of game media may be paid out per unit time compared to the normal game) and is capable of consuming the point value. However, it is preferable that the bonus game according to the present invention is a game in which no point value is offered. The type of the bonus game is not limited to a slot machine game and the examples thereof may include a card game and a video roulette game.

Further, in the present embodiment, there has been described a case where it is possible to additionally input the point value to be consumed (step S308 in FIG. 10), after the point value to be consumed is once inputted (steps S301 and S302 in FIG. 10). However, in the present invention, it may be configured such that it is impossible to add the point value to be consumed in that bonus game, once the point value to be consumed is inputted.

Further, in the present embodiment, there has been described a case where the number of executions of the free game constituting the bonus game is determined according to the consumed point value. However, in the present invention, an execution time period of the bonus game may be determined according to the consumed point value (for example, one minute for the consumption of one point, and four minutes for the consumption of two points).

Further, while in the present embodiment, the number of executions of the free game (unit game) is configured to increase exponentially with the to-be-consumed point value, in the present invention, the relationship between the point value to be consumed and the number of executions of the free game constituting the bonus game or the execution time period of the bonus game is not limited to the above-mentioned example. However, in the present invention, it is preferable that the number of executions of the unit game per unit point value is configured to increase with the increase of the point value to be consumed, or the bonus-game execution time period per unit point value is configured to increase with the increase of the point value to be consumed. By configuring like this, it is possible to enhance the player's motivation for accumulating a greater amount of point value to consume it at a time, thereby impressing the advantage of accumulating point value in the gaming card on the player.

Further, while in the present embodiment, there has been described a case where the slot machine game is executed as the normal game, the normal game according to the present invention is not particularly limited, provided that the normal game according to the present invention is a game in which a game medium maybe offered. Examples thereof may include a card game and a video roulette game.

Further, while in the present embodiment, the point value offered to the player is directly written into the gaming card 100 through the card reader 36, in the present invention, it may be configured such that the offered point value is temporarily stored in a RAM and then written into the gaming card.

Further, in the present embodiment, there has been described a case where the gaming machine 10 is communicably connected to the control server 300 through the communication line 201. However, the gaming machine according to the present invention is not particularly required to be connected to an external management device.

Further, while in the present embodiment, there has been described a case where a part of credits BET is cumulatively stored as a jackpot, in the present invention, the jackpot is not particularly required to be provided.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming machine comprising:
a writing device capable of writing information into a portable storage medium carried by a player;
a reading device capable of reading information from said portable storage medium; and
a controller,
said controller programmed to conduct the processing of:
(a) executing a mini game in which a point value may be offered to the player;
(b) writing said point value into said portable storage medium through said writing device;
(c) reading said point value written into said portable storage medium, through said reading device; and
(d) executing a bonus game, said bonus game is more advantageous to the player compared to a normal game in which a game medium may be offered and is capable of being executed by consuming said point value.

2. A gaming machine comprising:
a controller,
said controller programmed to conduct the processing of:
(a) executing a mini game in which a point value may be offered to the player;
(b) storing said point value in an external management device which is communicably connected to the gaming machine through a communication line;
(c) reading said point value stored in said management device; and
(d) executing a bonus game, said bonus game is more advantageous to the player compared to a normal game in which a game medium may be offered and is possible to be executed by consuming said point value.

3. The gaming machine according to claim 1,
wherein
said processing (a) is a processing of:
executing a mini game, in which said point value may be offered to the player, and said mini game is comprised of a plurality of steps and based on a result of the game in a single step, the game in a next step is started.

4. The gaming machine according to claim 1,
wherein
said controller is further programmed to conduct a processing of:
(e) executing said normal game; and
said processing (a) is a processing of:
executing said mini game while said normal game is played.

5. The gaming machine according to claim 1,
wherein
said processing (a) is a processing of:
executing said mini game while said bonus game is played.

6. The gaming machine according to claim 1 further comprising:
an input switch for inputting an amount of said point value to be consumed,
wherein
said controller is further programmed to conduct a processing of:
(f) determining the amount of said point value to be consumed in said bonus game, based on an input from said input switch, and
said processing (d) is a processing of:
executing said bonus game, which is more advantageous to the player compared to said normal game and is played by consuming the amount of said point value determined to be consumed in said processing (f).

7. The gaming machine according to claim 1,
wherein
said controller is further programmed to conduct a processing of:
(g) determining an execution time period of said bonus game based on the consumed amount of said point value.

8. The gaming machine according to claim 7,
wherein
said processing (g) is a processing of:
determining the execution time period of said bonus game so as to make said execution time period offered per unit point value be increased according to an increase of the amount of said point value to be consumed.

9. The gaming machine according to claim 1,
wherein
said controller is further programmed to conduct a processing of:
(h) determining the number of executions of unit games in said bonus game according to the consumed amount of said point value, said bonus game is comprised of a single or a plurality of said unit games, which is to be executed repeatedly, and
said processing (d) is a processing of:
executing said bonus game, which is more advantageous to the player compared to said normal game and is comprised of the number of said unit games predetermined in said processing (h).

10. The gaming machine according to claim 9,
wherein
said processing (h) is a processing of
determining the number of executions of said unit games, so as to make the number of executions of said unit games per unit point value be increased according to an increase of a consumed amount of said point value.
